(19) United States
(12) Patent Application Publication
(10) Pub. No.: US 2015/0095456 A1
(43) Pub. Date: Apr. 2, 2015

(54) REALTIME STATUS DATA DISPLAY WITH PUSH ADVERTISING

(71) Applicants: Ashok Deepak Shah, Atlanta, GA (US); Michael Kulkarni, Troy, MI (US); Christopher Lee Whitworth, Mooresville, NC (US)

(72) Inventors: Ashok Deepak Shah, Atlanta, GA (US); Michael Kulkarni, Troy, MI (US); Christopher Lee Whitworth, Mooresville, NC (US)

(21) Appl. No.: 14/502,640

(22) Filed: Sep. 30, 2014

Related U.S. Application Data
(60) Provisional application No. 61/884,651, filed on Sep. 30, 2013.

(51) Int. Cl. H04L 29/06; G06F 17/30; G06F 17/27; G06Q 30/02; H04L 29/08

(52) U.S. Cl. CPC H04L 65/60; G06Q 30/0277; H04L 67/02; H04L 67/26; G06F 17/2705; G06F 17/30091
USPC 709/217

(57) ABSTRACT

Technologies are described herein for aggregating and displaying status information and related media regarding an activity or event, such as a sports event, in realtime. A status display service is configured to retrieve status information regarding sporting events from multiple status data sources, parse the status information, store the status information in a database, and provide status information regarding a sporting event to a status display device in realtime. The status display device comprises a processor, a communication module, a display, and a memory containing code to allow the device to register interest in the sporting event with the status display service, receive the status information regarding the sporting event, and update the display according to the received status information.

### CROSS REFERENCE TO RELATED APPLICATION

This application claims the benefit of U.S. Provisional Patent Application No. 61/884,651, filed Sep. 30, 2013, and entitled “REALTIME STATUS DATA DISPLAY WITH PUSH ADVERTISING,” the entirety of which is hereby incorporated herein by this reference.

### BACKGROUND

Many sources for realtime or near-realtime sports information and media are available, including traditional broadcast television and radio, as well as a plethora of online sources. These online sources included realtime feeds through realtime syndication of data, such as current scores, time remaining, player stats, and the like. Beyond the conventional television or computer screen, there are limited numbers of ways for sports enthusiasts to consume this information. Non-conventional information and media presentation devices that can draw from these sources and provide a “game day” like experience would be popular with such enthusiasts. In addition, such devices may provide a means for advertisers to reach the enthusiasts in a non-intrusive manner.

It is with respect to these considerations and others that the disclosure made herein is presented.

### BRIEF DESCRIPTION OF THE DRAWINGS

FIG. 1 is a block diagram showing an illustrative environment for the implementation of an infrastructure supporting aggregating and displaying status information and related media regarding a sports event in realtime, according embodiments described herein.

FIGS. 2A-2C are diagrams showing illustrative displays of realtime status information and related media regarding a sports event, according to embodiments described herein.

FIG. 3 is a block diagram showing an illustrative hardware architecture for status display devices described in embodiments presented herein.

FIGS. 4 and 5 are flow diagrams showing illustrative routines for aggregating and displaying status information and related media regarding a sports event in realtime, according embodiments described herein.

### DETAILED DESCRIPTION

The following detailed description is directed to technologies for aggregating and displaying status information and related media regarding an activity or event, such as a sports event, in realtime. Utilizing the technologies described herein, a consumer graphical status display device and supporting infrastructure may be implemented that allows the display of status information and related media regarding a sports event, such as a game or tournament. A user of the status display device may register an interest in a specific sports event, such as a football or basketball game, a golf tournament, a sports tournament (e.g. NCAA basketball tournament), a fantasy sports league, and the like, with a cloud-based aggregation service. The status display device may then receive the status information regarding the sports event in realtime from the aggregation service over the Internet or other network, and update the associated display in order to follow the progress of the sports event. The status display device may be utilized by viewers in lieu of or in conjunction with other information regarding the progress of the sports event, such as following a broadcast of the event on television or radio.

The status display device may be portable in nature, employing batteries and wireless communications, allowing the device to be used in variety of environments for tailgating and other game day activities, for example. The status display device may be configured to resemble a scoreboard or other familiar context display of the status information and related media. The status display device may also be branded for specific users, such as including graphics and other indicia of the “home team.” According to some embodiments, the status display device may be able to receive and display advertising related to the sports events and/or profile information for the users stored by the aggregation service.

As utilized herein, “realtime” refers to the collection and display of realtime information with no configured or intentional delay, beyond the delay introduced by the collection, communication, and processing infrastructure. This may also be referred to as “near-realtime.” In the following detailed description, references are made to the accompanying drawings that form a part hereof and that show, by way of illustration, specific embodiments or examples. In the accompanying drawings, like numerals represent like elements through the several figures. The drawings are not drawn to scale.

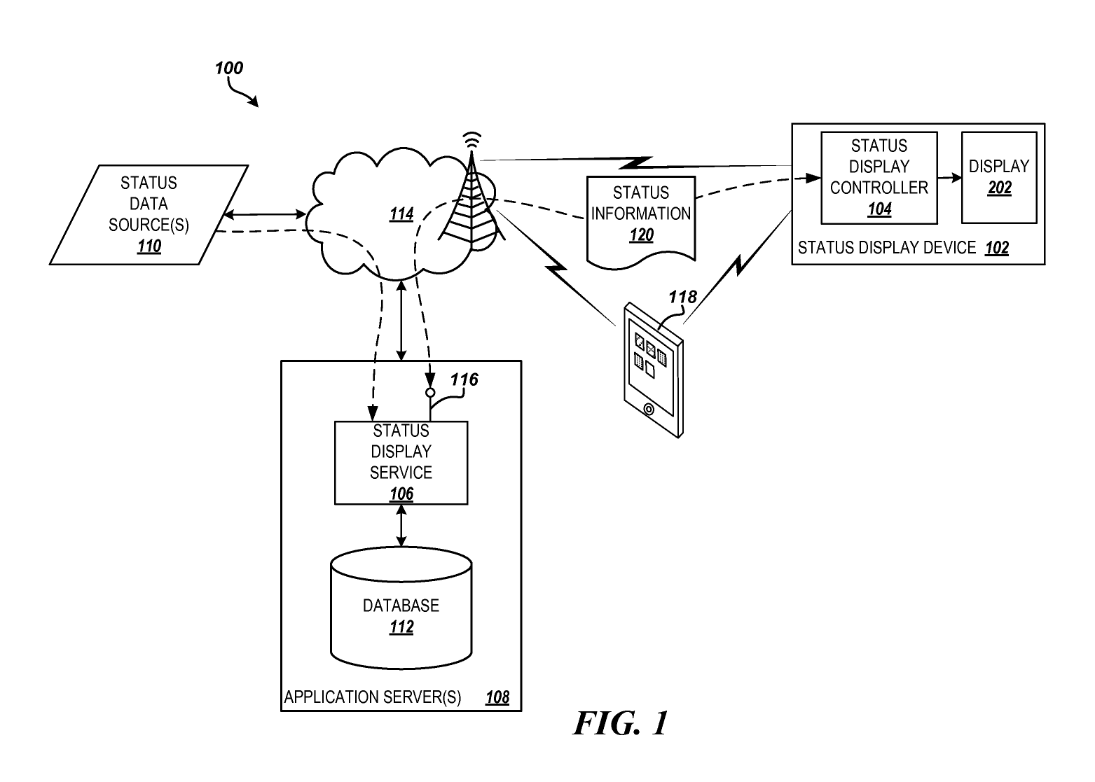

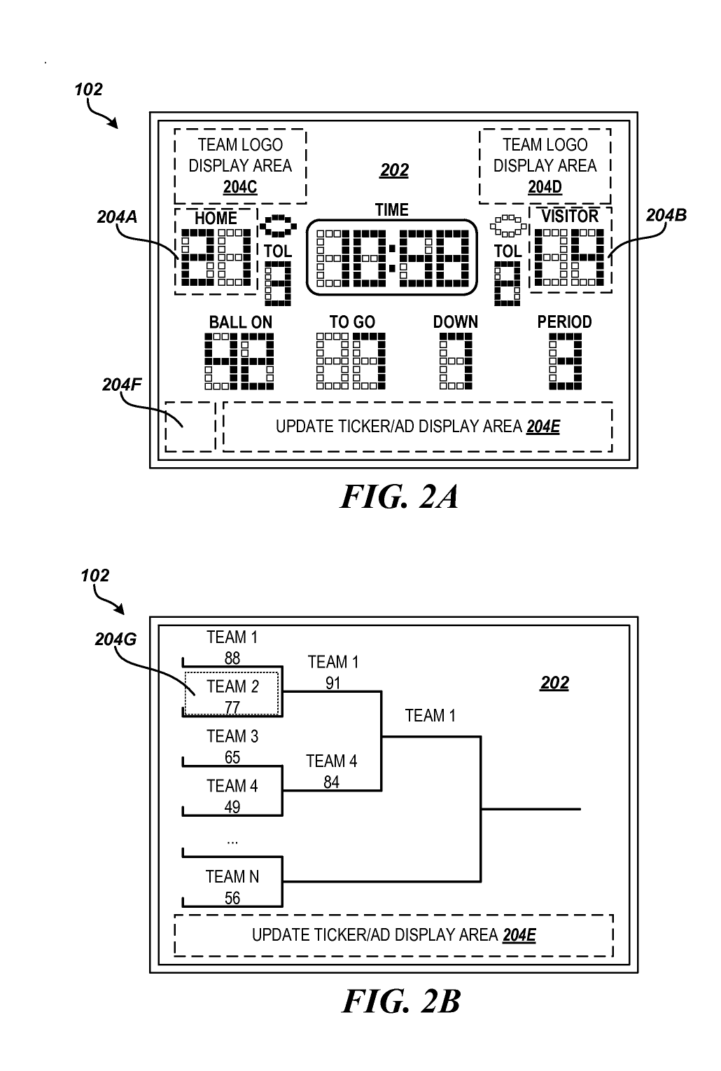

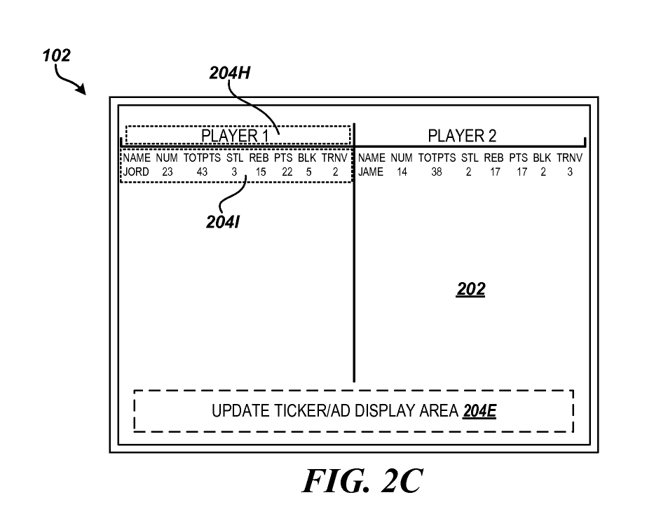

FIG. 1 shows an example operating environment 100 in accordance with the embodiments described herein. The environment 100 includes a status display device 102, such as a graphical display or “digital scoreboard” for realtime presentation of sports status information 120 and related media. The status display device 102 includes a display 202, which will be described in more detail in regard to FIGS. 2A-2C. The status display device 102 further includes a status display controller 104 that controls the retrieval and display of the status information 120 and related media on the display 202, as is described in more detail below.

According to some embodiments, the status display device 102 receives the status information and related media from a status display service 106. The status display service 106 may comprise application software executing on one or more application servers 108, for example. The status display service 106 may aggregate data from various status data sources 110 and store the aggregated data in a database 112. The status data sources 110 may provide near-realtime sports scores and game status information, team and player statistics, and the like. The status data sources 110 may comprise sports news web servers, athletic department web servers, search engines, news or information aggregation services, and the like. The status display service 106 may access the status data sources 110 over one or more public networks 114, such as the Internet, a wide-area network (“WAN”), a metropolitan-area network (“MAN”), and/or the like. The status display service 106 may receive status information and related media from the status data sources 110 via XML-based web services, Really Simple Syndication (“RSS”) feeds, XML file download, bot/web crawler scrapes of webpages or search engine results, or any combination of these and other access methods known in the art. The status display service 106 may receive the data via push feeds from the status data sources 110, through periodic polling of the data sources, or any combination of these and other information access methods known in the art.

The status display service 106 may further provide access to a user of the status display device 102, through a website or other online information service, that allows the user to create and maintain and account or profile with the service, register their status display device(s), and specify preferences and favorites. Preferences and favorites may include types of sports data to track, aggregate and provide for display, including, but not limited to, sports or genres of sports (e.g. basketball, football, etc.); team preferences, conferences, and regions (e.g. ACC, SEC, etc.); community or local sports (e.g. little league, high school, recreation, etc.); specific players (e.g. Fantasy Sports Teams), tournaments (e.g. NCAA playoffs), and the like. The user's account and profile information and preferences may be stored by the status display service 106 in the database 112. In addition to selecting data based on these preferences for display on the user's status display device 102, the status display device 106 may select target advertisements based on the profile data and preferences and favorites to be pushed to the user's status display device(s) 102.

The status display service 106 may further provide an API 116 for access to status information services by the status display device 102. The API 116 may allow the access the status display device 102 to connect and register interest in a specific sports event, such as a game, a tournament, a fantasy sports league, etc., for which the display device wishes to receive status information and related media for display. The API 116 may further provide for streaming of the status information 120 and media to the status display device 102 in realtime. The status display device 102 may access the API 116 and/or status display service 106 over the public network(s) 114 described above. For example, as will be described below, the status display controller 104 of the status display device 102 may include a communication module capable of multiple connection methods to the status display service 106 over the Internet, including cellular data connection, Wi-Max connection, Wi-Fi connection to an Internet-connected LAN, and the like.

In some embodiments, the status display device 102 may access the status display service 106 through an intermediate communications device 118, such as a smartphone, cellphone, PDA, tablet, mobile laptop computer, or the like. The intermediate communications device 118 may communicate with the status display device 102 via proximity-based or personal-area network (“PAN”) technologies or protocols, such as Bluetooth, Bluetooth LE, Wireless USB, near field communication (“NFC”), Wi-Fi, and the like and provide a gateway to communication with the status display service 106 over the public networks 114. For example, the status display device 102 may utilize a “personal hotspot” feature of the intermediate communications device 118 to provide a gateway connection to the status display service 106 over the Internet. In further embodiments, the connection between the status display device 102 and the intermediate communications device 118 may utilize a proprietary, low-power connection technology or protocol that is supported by both devices. For example, a dongle or connection device may be connected to an interface port of the intermediate communication device 118 that the device to establish a local connection with the status display device 102 utilizing the proprietary technology or protocol.

In further embodiments, the intermediate communication device 118 may execute a proprietary software application, or “app,” that provides the communication gateway for the status display device 102 to the status display service 106. In addition, the app may allow the user of the display device 102 to perform various account or profile maintenance functions, including setting up preferences, registration of the specific sports event for display of status information on the device, emulation of the device display in realtime, and the like. The intermediate communication device 118 and or app may further provide functionality for setting up the status display device 102; specifying account ID and/or authentication information for the status display service 106; selecting the specific sports event for display of status information on the device; selecting a display configuration on the display; changing technical settings of the device, such as power, brightness, or other settings; uploading firmware updates to the device; and the like.

As described above, the status display controller 104 may contain software logic that controls the retrieval and display of the status information 120 and related media on the display 202. The status display controller 104 may register an interest in a specific sports event with the status display service 106 via the communication link(s) described above. The status display controller 104 may further specify a display configuration for the display 202 with the request. The status display device 102 may then receive realtime status information 120 and related media regarding the sports event from the status display service 106. The status display controller 104 may then interpret and parse the received status information 120 and update the display 202 accordingly.

The status information 120 may comprise XML or other text-based information in a format optimized for efficient transmission to the status display device 102 utilizing low power and low bandwidth communication links. In some embodiments, the status display service 106 may stream the status information 120 to the status display device 102 utilizing any number of streaming protocols known in the art. In other embodiments, the status display service 106 may utilize a proprietary protocol to stream the status information 120 to the status display device 102 that is optimized for minimal power usage and communication bandwidth. In further embodiments, the status display device 102 may periodically poll the status display service 106 to receive realtime status information 120 and related media regarding the sports events of interest and update the display 202 accordingly.

According to some embodiments, the status display controller 104 may implement additional functionality, such as functionality to traverse firewalls and create a link to the status display service 106 across multiple, disparate networks 114; the ability to simulate certain realtime status information for display, such as time remaining in a game; the ability to wake and sleep between transmissions of status information based on preferences or realtime scheduling of status information delivery to reduce power consumption; the ability to intermittently wake up and identify the status display device 102 to the status display service 106, validate preferences, and schedule delivery of status information 120; and the like. In further embodiments, the status display controller 104 may implement the functionality to access status information 120 related to a sports event directly from the status data sources 110 across the public network(s) 114, and parse and display the status information on the display 202, without the need of an intervening status display service 106.

As shown in FIGS. 2A-2C, the display 202 may comprise multiple information display areas 204A-204F (referred to herein generally as display areas 204) that display specific status information elements. In some embodiments, each display area 204 may comprise an independently controllable display device, such as an LED display, OLED display, LCD, and the like. In other embodiments, the display 202 may comprise a single display device, such as a graphical LED display, OLED display, LCD, with the individual display areas 204 comprising addressable areas of the display 202.

According to some embodiments, the display areas 204 may be arranged on the display 202 to mimic a traditional sports scoreboard, as shown in FIG. 2A. Some display areas, such as the home team score shown at 204A and the visitor team score shown at 204B, may comprise numeric-type displays, such as a dot-matrix display, 7-segment display, and the like, designed to mimic those of a traditional scoreboard display. Other display areas may utilize generic LED displays, OLED displays, LCDs, or the like for displaying multiple types of data, such as graphical images, text or numeric displays, and the like. For example, the team logo display areas 204C and 204D may show graphical team logos or a simple, text-based team names depending on the available data. In some embodiments, the display 202 may further include static features, such as labels and graphics, to complete the scoreboard display. These static features may be applied to the surface of the display 202, or shown within the display elements of the display.

According to further embodiments, the display may include an update ticker/ad display area 204E for the display of ticker status information and/or advertising information related to the sports event information shown on the display 202. The update ticker/ad display area 204E may comprise a dot-matrix text display, a graphical LED, OLED, or LCD display, or the like. The status display service 106 may be configured to push advertisements and/or other solicitations to the status display device 102 based on a user's favorites, preferences, and profile information stored in the database 112, and the advertisements may be displayed in the update ticker/ad display area 204E. In some embodiments, the pushed advertisements may periodically replace some or all of the entire display 202 based on the status of the sports event (e.g. timeout), an advertising schedule, user preferences, and/or the like.

In some embodiments, the display 202 may further include a code display area 204F allowing a QR code or barcode to be overlaid or otherwise displayed on the display that can be scanned by users of the status display device 102 to provide augmented reality information via smartphone or other connected devices, such as video highlights, commentary, statistics, advertising, and the like, related to the sports event information currently displayed on the display 202.

As shown in FIGS. 2B and 2C, other configurations of the display 202 are contemplated and supported by the disclosure herein. For example, the display 202 may be configured to show tournament bracket information in realtime, such as the outcome of a sports tournament, as shown in FIG. 2B. Each display area, such as display area 204G may show an individual outcome in the bracket with the structure of the bracket applied to the surface of the display 202 or shown within the display elements of the display. Similarly, the display 202 may be configured to show realtime team or player statistics and other information regarding a fantasy sports league for one or more users, as shown in FIG. 2C. The display areas 204H and 204I may show user names, individual selected player names and statistics, and the like. Many other configurations of the display 202 will become apparent from a reading of this disclosure, including a NASCAR pole standings display, a golf leaderboard, a horse racing odds board, and the like. It is intended that all such configurations be include in this disclosure.

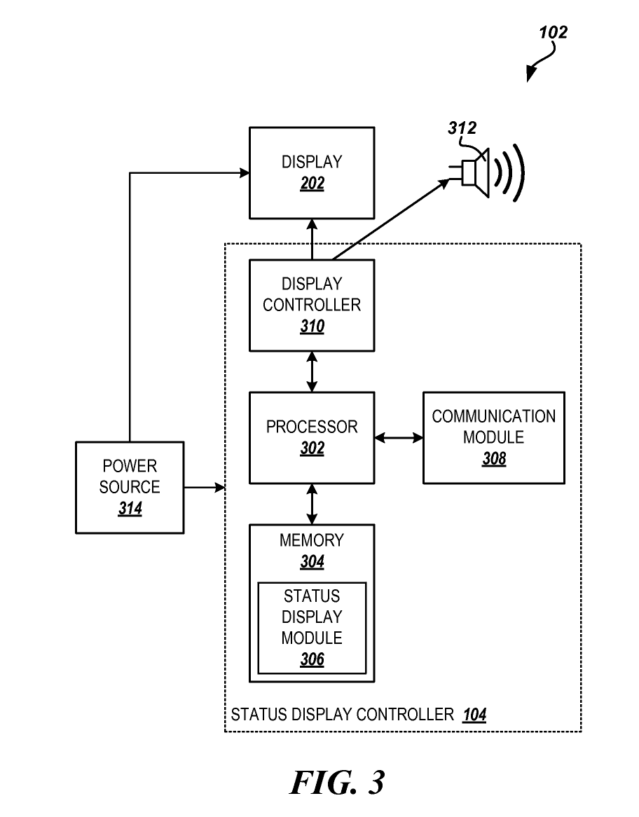

FIG. 3 provides an illustrative schematic of the status display device 102, including the status display controller 104. The status display controller 104 may comprise a processor 302 for executing logic to retrieve the status information 120 and related media, parse the information elements, and update the display areas 204 of the display 202 accordingly, as described herein. The processor 302 may comprise a general-purpose processor, a PLC, an FPGA, or other processing component known in the art.

The status display controller 104 may further include a computer-readable storage medium or “memory” 304 for storing processor-executable instructions, data structures and other information used by the processor 302. The memory 304 may comprise a non-volatile memory, such as read-only memory (“ROM”) and/or FLASH memory, and a random-access memory (“RAM”), such as dynamic random access memory (“DRAM”) or synchronous dynamic random access memory (“SDRAM”). For example, the memory 304 may store a status display module 306 that comprises processor-executable instructions and data necessary for performing the operations of the status display device 102 as described herein. According to some embodiments, the memory 304 may store processor-executable instructions that, when executed by the processor, perform the routine 500 for retrieving status information and related media regarding a sports event and displaying the status information in realtime, as described herein.

In addition to the memory 304, the environment 100 may include other computer-readable media storing program modules, data structures and other data described herein for aggregating and displaying status information and related media regarding a sports event in realtime on a status display device. It will be appreciated by those skilled in the art that computer-readable media can be any available media that may be accessed by the status display controller 104, the application server(s) 108, or other computing systems, including computer-readable storage media and communications media. Communications media includes transitory signals. Computer-readable storage media includes volatile and non-volatile, removable and non-removable storage media implemented in any method or technology for the non-transitory storage of information. For example, computer-readable storage media includes, but is not limited to, RAM, ROM, EPROM, EEPROM, FLASH memory or other solid-state memory technology, CD-ROM, DVD, BLU-RAY or other optical storage, magnetic cassettes, magnetic tape, magnetic disk storage or other magnetic storage devices and the like.

The status display controller 104 further includes a communication module 308. The communication module 308 may comprise one or more radios for establishing wireless communication links with the status display service 106 and/or intermediate communication device 118. The communication module 204 may implement any combination of a Wi-Fi radio or any of its variants (e.g. Wi-Fi direct), a Bluetooth or Bluetooth low-energy (“LE”) radio, and the like. The communication module 308 may further implement a cellular modem, allowing the status display device 102 to have enhanced portability. The status display controller 104 further includes a display controller 310 that allows the processor 302 to interface with and control the various display areas 204 of the display 202. The display controller 310 may further drive an audio speaker 312 in the status display device 102. The speaker 312 may allow the status display controller to play audio media related to the sports event received from the status display service 106 or other source over the communications links, including live audio coverage of the sports event, “fight songs” or other meaningful audio related to a team or its identity, audio highlights from a game, or simulated audio “cheering” during status changes, such as a score by one of the teams, audio advertisements pushed to the device by the status display service 106, and/or the like.

The status display device 102 further includes a power source 314 that provides power to the display 202 and the status display controller 104. To enhance the portability of the status display device 102, the power source 314 may include batteries, ultra-capacitors, or the like. The batteries may be replaceable and/or rechargeable. The power source 314 may further include an AC to DC power supply with trickle charge capability, a DC to DC power supply with trickle charge capability (for power/charging in an automobile, for example), or some other source of power and charging of the batteries or ultra-capacitors. In addition, the status display device 102 may include motion detectors and/or ambient light sensors in order to dim the display 202, delay or suspend updates of status information 120 or shut off the device, or perform other power savings measures when no users are present and/or in low light situations. It will be appreciated that the status display device 102 and/or status display controller 104 may not include all of the components shown in FIG. 3, may include other components that are not explicitly shown in FIG. 3, or may utilize an architecture completely different than that shown in FIG. 3.

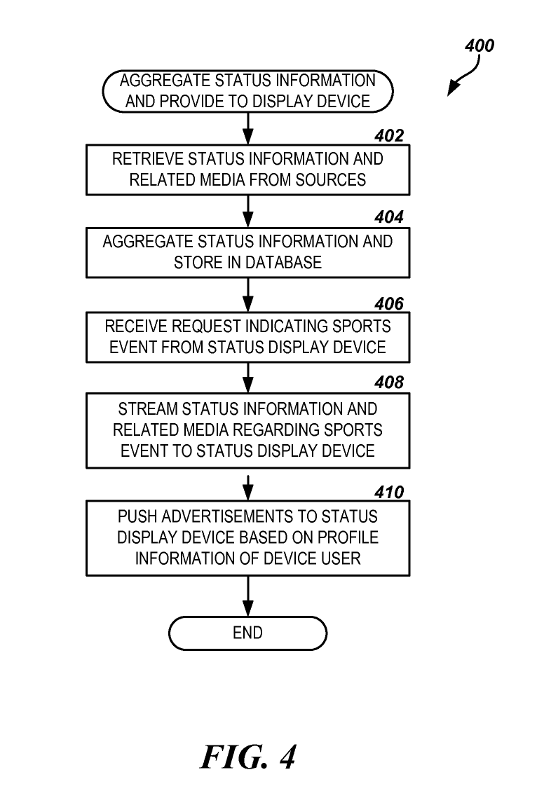

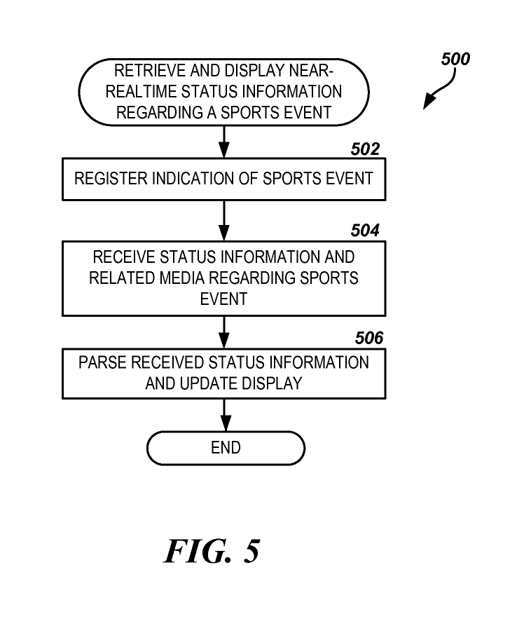

Referring now to FIG. 4, additional details will be provided regarding the embodiments presented herein. It should be appreciated that the logical operations or steps described with respect to FIGS. 4 and 5 are implemented (1) as a sequence of computer implemented acts or program modules running on a processor, PLC, or other computing device and/or (2) as interconnected machine logic circuits or circuit modules within the various components and modules described herein. The implementation is a matter of choice dependent on the components selected in the implementation of the status display device 102, the application server(s) 108, or the intermediate communications device 118, as well as the performance and other requirements of the system. The logical operations described herein may be implemented in software or firmware of a device or computer system, in software or firmware within a microcontroller, in special purpose digital logic circuits, or any combination thereof. It should also be appreciated that more or fewer operations may be performed than shown in the figures and described herein. The operations may also be performed in a different order than described.

FIG. 4 illustrates a routine 400 for aggregating sports data and providing the sports data in realtime to a status display device 102, according to one embodiment. The routine 400 may be executed by the status display service 106 executing on one or more application servers 108, for example. The routine 400 begins at operation 402, where the status display service 106 retrieves status information and related media regarding sports events, teams, players, and the like from various status data sources 110. The status display service 106 may receive the status information and related media from the status data sources 110 via XML-based web services, RSS feeds, XML file download, bot/web crawler scrapes of webpages or search engine results, or any combination of these and other access methods known in the art. The status display service 106 may receive the data via push feeds from the status data sources 110, through periodic polling of the data sources, or any combination of these and other information access methods known in the art.

From operation 402, the routine 400 proceeds to operation 404, where the status display service 106 parses, interprets, and aggregates the retrieve status information. The status display service 105 may further store the aggregated information and related media in a database 112. The routine 400 then proceeds to operation 406, where the status display service 106 receives a request from a status display device 102 indicating a sports event for which the display device wishes to receive and display status information 120 and related media. The request may be received from the status display device 102, or the request may be received from an app on an intermediate communications device 118 associated with the status display device. The request may further specify a display configuration for the status display device 102.

The routine 400 proceeds from operation 406 to operation 408, where the status display service 106 provides status information 120 and related media regarding the indicated sports event to the status display device 102 in realtime. The status information 120 and related media may be obtained directly from the status data sources 110 and/or retrieved for the database 112. The status information 120 may be streamed to the status display device 102 or the device may periodically pole the status display service 106 for updated status information 120 on a scheduled basis.

From operation 408, the routine 400 proceeds to operation 410, where the status display service 106 may periodically push advertisements to the status display device 102 for display to users of the device. The advertisements may be selected based on the sports event for which status information is being provided, the users' profile, preferences, and favorites stored in the database, and the like. From operation 410, the routine 400 ends.

FIG. 5 illustrates a routine 500 for retrieving status information and related media regarding a sports event and displaying the status information in realtime, according to some embodiments. The routine 500 may be executed by the status display module 306 executing on the status display controller 104 of a status display device 102, for example. The routine 500 begins at operation 502, where the status display module 306 registers interest in a sports event with the status display service 106 described above. Next, at operation 504, the status display module 306 receives status information 120 and related media regarding the sports event in realtime from the status display service 106. The status display service 106 may stream the status information 120 to the status display device 102 or the device may periodically pole the status display service 106 for updated status information 120 on a scheduled basis.

From operation 504, the routine 500 proceeds to operation 506, where the status display module 306 parses and interprets the received status information 120, and updates the display 202 of the status display device 102 accordingly. The status display module 306 may parse specific information elements from the status information 120 and update individual display areas 204 of the display 202, according the display configuration of the device. In some embodiments, some information elements may be simulated and updated on the display to reflect estimated realtime information, such as the time remaining in a period. From operation 506, the routine 500 ends.

While the status display device 102 and status display service 106 shown in the figures and described herein generally show and provide status information related to a sports event, it will be appreciated that the technologies described herein may be utilized to aggregate and present a contextualized display of status information regarding any event, group, organization, or the like. For example, the status display service 106 may be configured to collect information regarding family events or activities from status data sources 110 comprising the smartphones and/or PDAs of family members or from email or calendaring services utilized by family members and aggregate the information in the database 112. The activities or events may include children's after school activities, work schedules, homework schedules, dinner plans, weekend sports events, and the like.

The status display service 106 may further be configured to receive SMS text messages containing notes left for/by children, parents, babysitters, or the like. The status display device 102 may then access the aggregated family activity/event information from the status display service 106 and display calendar information, weather information, notes, and the like for consumption by family members. Other applications of the technologies described herein for aggregating and displaying status information and related media in near-realtime regarding activities or events may be conceived by one skilled in the art upon a reading of this application, and it is intended that all such applications be included in this application.

Based on the foregoing, it should be appreciated that technologies for aggregating and displaying status information and related media regarding activities/events, such as a sports event, in near-realtime are provided herein. The subject matter described above is provided by way of illustration only and should not be construed as limiting. Various modifications and changes may be made to the subject matter described herein without following the example embodiments and applications illustrated and described, and without departing from the true spirit and scope of the present invention.

The logical operations, functions or steps described herein as part of a method, process or routine may be implemented (1) as a sequence of processor-implemented acts, software modules or portions of code running on a controller or computing system and/or (2) as interconnected machine logic circuits or circuit modules within the controller or computing system. The implementation is a matter of choice dependent on the performance and other requirements of the system. Alternate implementations are included in which operations, functions or steps may not be included or executed at all, may be executed out of order from that shown or discussed, including substantially concurrently or in reverse order, depending on the functionality involved, as would be understood by those reasonably skilled in the art of the present disclosure.

It will be further appreciated that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

Many variations and modifications may be made to the above-described embodiments without departing substantially from the spirit and principles of the present disclosure. Further, the scope of the present disclosure is intended to cover any and all combinations and sub-combinations of all elements, features and aspects discussed above. All such modifications and variations are intended to be included herein within the scope of the present disclosure, and all possible claims to individual aspects or combinations of elements or steps are intended to be supported by the present disclosure.

What is claimed is:

1. A system comprising:
a status display service configured to:
retrieve status information regarding sporting events from a plurality of status data sources across the Internet,
parse the status information,
store the status information in a database, and
provide status information regarding a sporting event to a status display device in realtime; and
the status display device comprising:
a processor,
a communication module,
a display, and
a memory operably connected to the processor and containing processor-executable instructions configured to cause the processor to:
register interest in the sporting event with the status display service via the communication module,
receive the status information regarding the sporting event via the communication module, and
update the display according to the received status information.

2. The system of claim 1, wherein the display device communicates with the status display service via an intermediate communication device.

3. The system of claim 2, wherein the intermediate communication device comprises a cellphone of a user of the display device.

4. The system of claim 2, wherein the display device communicates with the intermediate communication device via a proximity-based or personal-area network.

5. The system of claim 1, wherein the display is configured to resemble a scoreboard for the sporting event.

6. The system of claim 5, wherein the display comprises a plurality of display areas, each display area corresponding to an element of the scoreboard, and wherein the processor further parses the received status information and updates each display area of the display accordingly.

7. The system of claim 1, wherein the status information includes data and media regarding the sporting event.

8. The system of claim 1, wherein the status display service is further configured to stream the status information to the status display device over the Internet.

9. The system of claim 1, wherein the status display service is further configured to periodically push advertisements to the status display device for display on the display.

10. A non-transitory computer-readable storage medium containing processor-executable instructions that, when executed by a processor, cause the processor to:
register an interest in one or more sporting events with a status information service;
periodically receive status information regarding the one or more sporting events from the status information service at a display device; and
update a display of the display device based on the received status information, the display configured to display the status information in a contextual format related to the one or more sporting events.

11. The computer-readable storage medium of claim 10, wherein the display device communicates with the status information service via an intermediate communication device.

12. The computer-readable storage medium of claim 10, wherein the display is configured to resemble a scoreboard for the one or more sporting events.

13. The computer-readable storage medium of claim 12, wherein the display comprises a plurality of display areas, each display area corresponding to an element of the scoreboard and updated based on corresponding data or media contained in the received status information, the display further comprising static elements corresponding to the scoreboard.

14. The computer-readable storage medium of claim 10, containing further processor-executable instructions that cause the processor to:
simulate realtime data regarding the one or more sporting events based on the periodically received status information; and
update aspects of the display to reflect the simulated realtime data.

15. The computer-readable storage medium of claim 10, containing further processor-executable instructions that cause the processor to:
periodically receive advertisements related to one or more sporting events or viewers of the one or more sporting events; and
display the advertisements in a portion of the display.

16. A method for displaying status information regarding sporting events, the method comprising:
retrieving status information regarding the sporting events from a plurality of status data sources across the Internet;
parse the status information;
storing the status information in a database;
receiving a registration of interest in a sporting event of the sporting events, the registration of interest associated with a status display device; and
providing the status information regarding the sporting event to the status display device, the status information displayed by the status display device in a contextual format related to the sporting event.

17. The method of claim 16, wherein the status information comprises data and media related to the sporting event, and wherein the status display device is configured to display the media and update the display based on the data based on a context of a progression of the sporting event.

18. The method of claim 16, wherein the display is configured to resemble a scoreboard for the sporting event and wherein the status information is provided to the status display device in near-realtime.

19. The method of claim 16, further comprising:
periodically pushing advertisements related to one or more sporting events or viewers of the one or more sporting events to the status display device, the status display device configured to display the advertisements.

20. The method of claim 16, wherein the status information is streamed to the status display device over the Internet.
